(19) United States
(12) Patent Application Publication
(10) Pub. No.: US 2009/0162032 A1
(43) Pub. Date: Jun. 25, 2009

(54) Smart Viewing Rights System and Switch

(75) Inventor: Pankaj Patel, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: ACEURITY, INC., Fremont, CA (US)

(21) Appl. No.: 11/963,608

(22) Filed: Dec. 21, 2007

(51) Int. Cl. H04N 5/91

(52) U.S. Cl. 386/123

(57) ABSTRACT

A method and apparatus that enables the transfer of viewing rights on an individual basis that allows the individual to view high-definition content from any source when the rights are available. If the viewing rights of the high-definition version are not available to a viewer the same content may be viewed at lower definition. Hence the invention enables moving of the viewing rights with an individual rather than a content viewing terminal. It also allows the content to be reviewed in very low preview resolution but prevents the use in higher resolutions till rights are secured. The benefit is securing and guarding the rights for high-definition reproduction but allowing low quality viewing by using the same compressed content. The HDMI-in to HDMI-out format used in the implementation makes viewing of content from all sources possible, whether directly streamed or from a pre-stored location.

### BACKGROUND OF THE INVENTION

1. Field of the Invention

The disclosed invention relates generally to management of viewing rights and more specifically, to the enablement of mobility of viewing rights with individuals rather than viewing rights being tied to a specific display apparatus and/or specific content.

2. Prior Art

Present real time content transmission systems use complex encryption/decryption schemes with key exchange schemes to provide security and protect the content from unauthorized viewing on a display device. Today's viewing permission granting process is a complex procedure that is dedicated to a display device and/or specific content and is done each time a program is viewed. For every end point (display device or box and/or content) a unique reservation and encryption of content is undertaken. A decryption key exchange with a reservation number has to take place for each customer request to enable the decryption of the uniquely encrypted content and its consumption at the viewing terminal.

FIG. 1 shows such a typical permission granting process. Accordingly, the consumption of streaming content or media by a consumer or viewer uses an enhanced service routing processor (ESRP) 110, a real time switch management system (RTSMS) 150, a reservation server (RS) 140, a name reservation processor (NRP) 160 and a managed media switch (MMS) 170. The ESRP 110, receives and manages the content according to the media rules 111. Order processing requirements 112 establishes and distributes the media or content to the MMS 170 as approved. When a viewer makes a media request 131, from a viewing terminal 130, the RTSMS 150 receives the viewer's media request and payment information 141 through the connected RS 140. The RTSMS 150 processes the information to build a reservation, including the encryption and decryption keys, for the requested media. This reservation 151, that is authenticated and paid for, is passed on to the NRP 160. The reservation information is also passed on to the viewer for the use of the decryption key 142 to be used on the encrypted content. The NRP 160 receives the reservation data and viewer information 151 from the RTSMS 150 and identifies a MMS 170 that can stream the encrypted media 172 to the viewer terminal 130. The NRP 160 sends the reservation data and customer data 161 to the MMS 170 and the IP address 162 of the MMS 160 to the viewer terminal 130. The viewer terminal 130 initiates the session using the reservation information. If reservation data from viewer terminal 130 match the reservation information in MMS 170, a viewing session is established. Even though the system allows content to be downloaded and stored, an uplink has to be available for initiating the key exchange, continuous authentication of the viewing terminal and consumption prior to and during the viewing session. Typically there is a retention time limit for the decryption key to prevent multiple viewing and viewing beyond the allowed viewing period.

As can be seen from the description of the streaming media viewing right process described above, a number of operations, outside the viewer's control, have to take place for each session to be established. External links have to be established for each connection for authentication and a key transfer must take place too. Even when the viewer receives the permission to establish the session, it is only established to a specific viewing or decoding terminal and/or specific content and cannot be changed or transferred.

Cinema quality or high quality video viewing is an aspiration that is being worked towards by the content producers and distributors. Infrastructure to handle transmission to individual display devices are being developed at present. FIG. 2 shows the transmission and reception of content as it happens today. The content from the content provider 201 is encoded using the H.264 standard for video compression, which is also known as moving picture experts group video encoding and compression (MPEG-4 Part 10), or advanced video coding (AVC). This encoded content 212 is then transmitted by any one of cable 211A, Ethernet 211B or satellite 211C to the decoder 220 at the receiver site. The decoder decrypts the content. The content can then be transferred over high-definition multimedia interface (HDMI) with high-bandwidth digital content protection (HDCP) enabled or using the (HDMI/HDCP) interface 214, to the high definition TV (HDTV) 240 for viewing as high quality video content. The decoded content that is transcoded can also be stored for future medium quality viewing, using currently available lossy compression schemes, in storage medium 230 using available serial or parallel bus 213. The compressed storage can be in DVD, HD-DVD, Blu-Ray, DVR or any other storage configuration.

FIG. 3A shows the current transmission scheme of video content having differing quality levels. Typical high-definition (HD) quality video is transmitted separate from the video home system (VHS) quality video. When HD is paid for the HD quality is made available. If not the typical content display is at VHS quality only.

FIG. 3B shows the next generation transmission where cinema HD quality will be made available. In this case it will be necessary to control the output or viewing quality using a device that can change or modify the output from a single input stream.

One of the other areas of concern that has existed, and still exists, is the capability to provide individual viewing rights. The individual may be at home or on the move and would like to have the rights to continue viewing the programs, the rights to which he purchased, on different viewing devices that are at his disposal. He would also like the right to view the content he has downloaded at periods or places where there is no uplink to initiate a key exchange.

In view of the limitations of the prior art it would be advantageous to provide a solution for associating the viewing rights to an individual rather than a display/decode unit and/or specific content. Enabling the capability for individual viewing rights rather than the preset display and/or specific content based viewing rights will enhance the viewing experience of the individual and hence improve the return to the content providers and/or broadcast operators.

### BRIEF DESCRIPTION OF THE DRAWINGS

FIG. 1 is a typical prior art video on demand implementation.

FIG. 2 is a typical prior art transmission and reception scheme for content.

FIG. 3A is a diagram of the frequency usage for standard HD transmission.

FIG. 3B is a diagram of the proposed frequency usage for HD transmission.

FIG. 4 is a functional block diagram of the viewing rights enabling system (VRES).

FIG. 5 is a block diagram of the VRES as implemented in a Viewing rights management switch (VRMS).

FIG. 6 is a block diagram of the VRES as implemented is a viewing rights management switch having dual elements of a mobile unit and a fixed unit.

FIG. 7 is a flowchart showing the principles of operation of the disclosed invention.

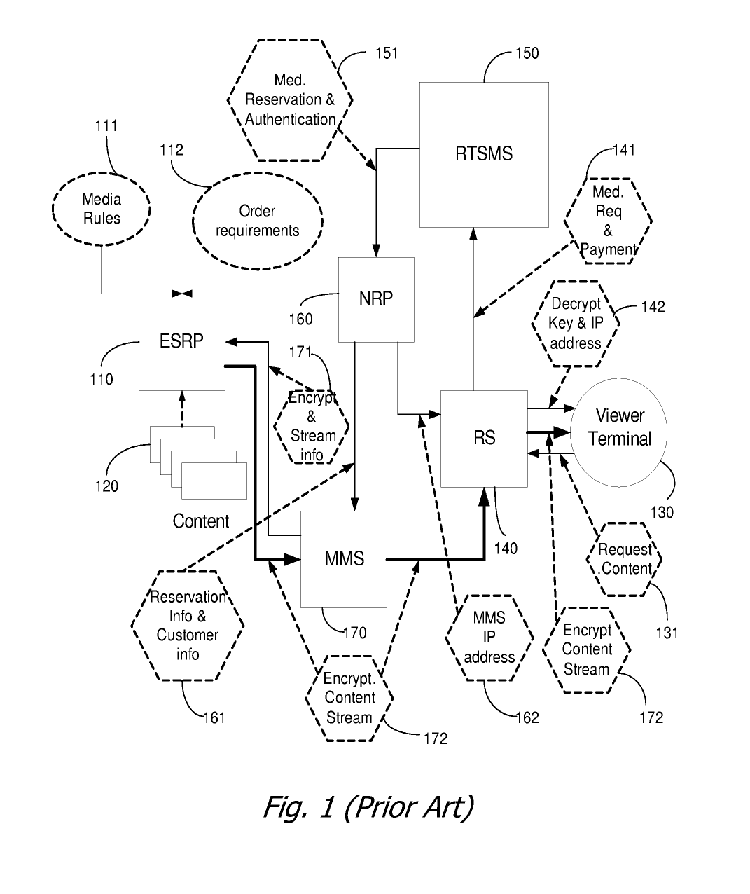

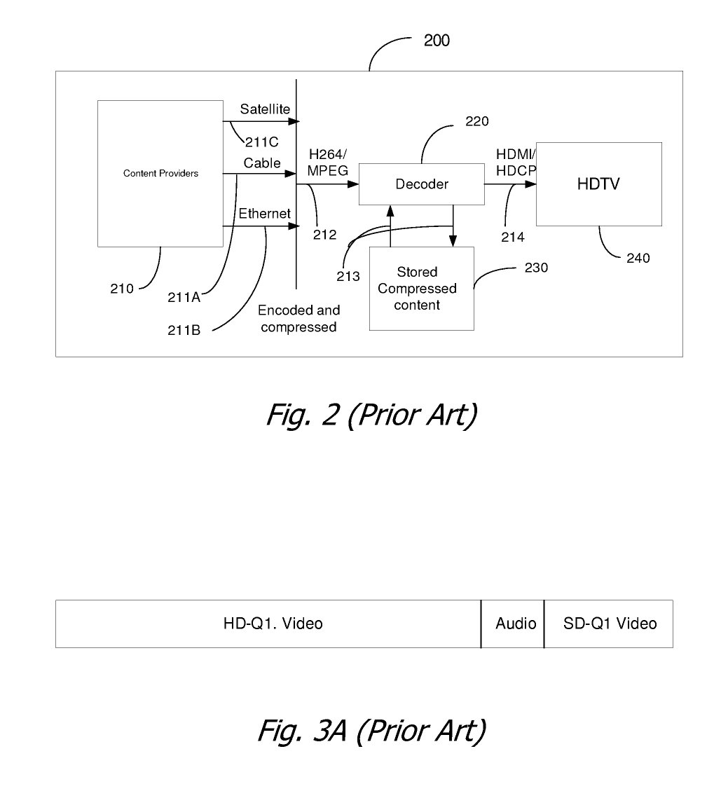

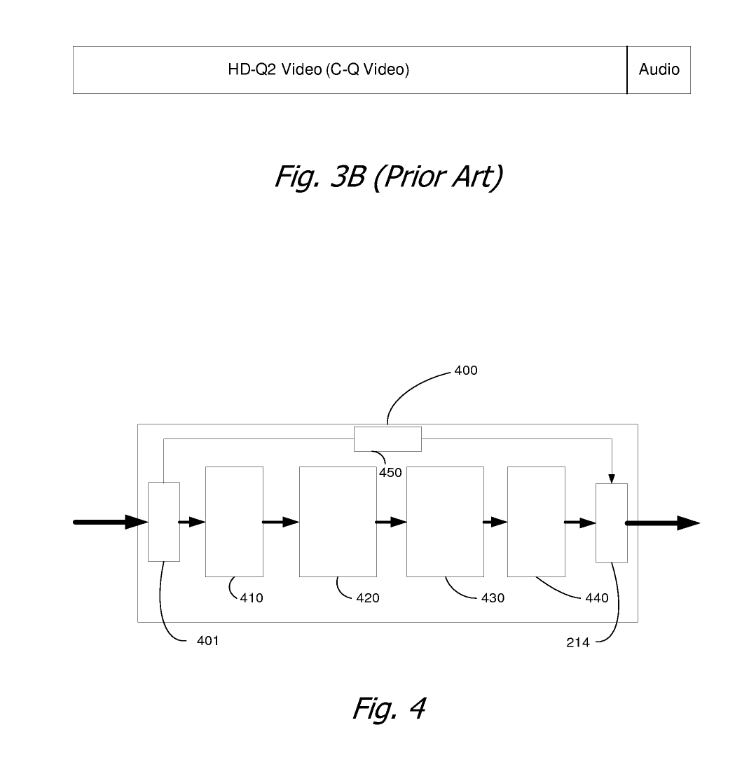

### DETAILED DESCRIPTION OF THE PREFERRED EMBODIMENTS

A method and an apparatus that enables the transfer of viewing rights on an individual basis thereby allowing viewing of high-definition content, from any source when the rights are available. If the viewing rights of the high-definition version are not available to a viewer the same content may be viewed at lower definition. Hence the invention enables moving of the viewing rights with an individual rather than a content viewing terminal. It also allows the content to be reviewed in very low preview resolution but prevents the use in higher resolutions till rights are secured. The benefit is securing and guarding the rights for high-definition reproduction but allowing low quality viewing by using the same compressed content. The HDMI-in to HDMI-out format used in the implementation makes viewing of content from all sources possible, whether directly streamed or from a pre-stored location.

The disclosure provides a way of enabling paid for viewing of any content from any source, such as any producer, distributor, supplier, or pre stored, independent of the content viewing terminal or operating system. It is possible to have this capability independent of the individual content stream, the type of viewing terminals used or operating system. The block diagram 400 shown in FIG. 4 depicts the individually transferable, typically paid for, viewing rights enabling system (VRES) 400 in accordance with an embodiment of the disclosed invention. The VRES 400 has an input interface unit 401 and an output interface unit 214, both being preferably in the HDMI/HDCP format and requiring no other decoding within the VRES 400. The removal of HDCP and re-introduction of HDCP happens at the input interface unit 401 and output interface unit 214, in the VRES 400. The output interface unit 214 of VRES 400 is typically attached to a HDMI input terminal of a viewing terminal 240. In a typical VRES 400, the audio portion of the digital content stream is also separated at the input interface unit 401 and processed in the audio processing unit 450. It is recombined at the output interface to output the content stream. The use of HDMI/HDCP enables the system to be insensitive to transmission and decoding methods used, and allows the VRES 400 to function with no changes as new content transmission methods are implemented. The incoming content stream over the HDMI interface has its HDCP compression and security removed in the interface unit and this content stream is checked for prior water-marking, to ensure that it is not a pirated copy, in watermark checking unit 410. The content stream is then passed to the viewing rights permission unit 420 which separates out permission requirements associated with the content stream as metadata. This viewing rights permission unit 420 checks for the viewing rights permission, stored as metadata within the VRES 400 system, against the metadata of permission requirement as extracted form the content stream. If the viewing permission is not available, or the permission available does not match the requirement as specified in the video content, or if only a lower quality permission is available, this information is provided to the quality adjust unit 430. The content stream is also passed to the quality adjust unit 430 at the same time. The quality adjust unit 430 adjusts the quality level of the content to the appropriate quality level. This is done based on the permission information provided to quality adjust unit 430 by the viewing rights permission unit 420. The viewing quality level can be one of four levels, high quality HD permission, low quality video permission, preview permission, or, blocking of the content stream. The next unit, the water mark unit 440, appends a watermark in the form of metadata to the video content stream indicating viewing of the video content by the user at the appropriate quality level. This is then output to the HDMI output interface for viewing on a suitable viewing terminal.

The HDMI/HDCP is the content transmission and protection scheme that is standard for all future generation viewing terminals. The content received for viewing is decoded by the decoder which can be of different types, based on the source of the incoming content stream. These typically include cable, Ethernet or satellite in typical formats like MPEG or H264. The sources of input received can also be output from pre-recorded content, recorded on high density storage mediums, again in different formats, like Blu-Ray, Digital Video Disc (DVD), High Definition Digital Video Disc (HD-DVD), Tivo®, Digital Video Recorder (DVR) etc. The storage today is done only at the decoder as the decoded output in HDMI is in the frame format and is too large for practical storage as high quality video. Once decoded the output is presented as HDMI/HDCP output. The VRES is connected between the HDMI outputs of the decoders and the HDMI input of viewing terminal 240. This allows the VRES 400 to be insensitive to the varying source and formats of the received content streams.

The proposed VRES 400, implemented using a viewing rights management switch (VRMS) after content has been decoded, allows the viewing rights to be associated with the individual or owner of the VRMS, rather than the viewing terminal. Having the capability to perform viewing rights management on the decoded output after decode rather than during decode, decouples the coding schemes and units from the enabling VRMS.

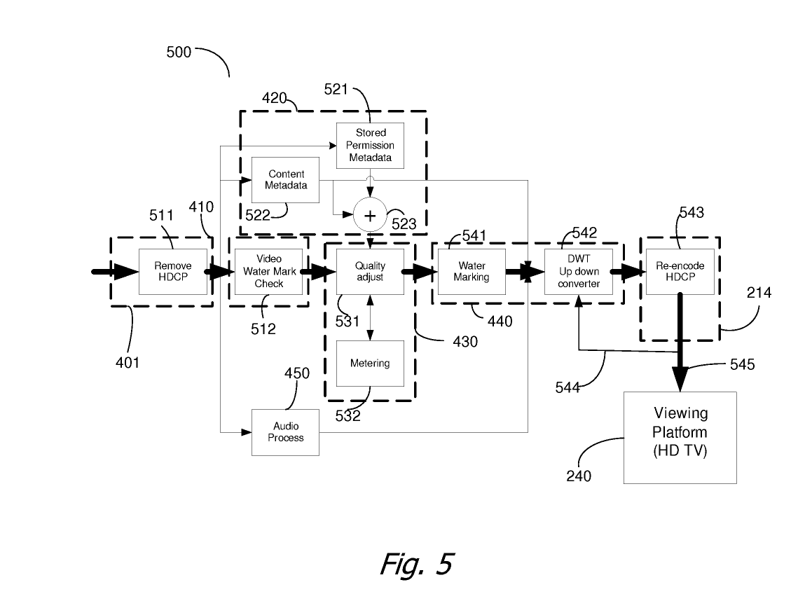

The VRMS 500, shown with respect to FIG. 5, is a portable switch that encompasses the VRES 400 implementation in an individually owned switch. The VRMS 500 accepts typical content streams 401 over HDMI with HDCP enabled. The HDCP protection is first removed from the content stream and the video, audio and available information metadata are separated in the input interface unit 511. The relevant part of the metadata that is required for viewing rights management is extracted from the content stream by the metadata extraction unit 522. This is compared in the checker 523 with the permission information that is stored as metadata in a permission storage 521 within the VRMS 500. The units 522 and 523 together form the viewing rights permission unit 420. The compared output is applied to the quality adjust unit 531 to define the allowed quality level and permissibility of viewing of the content. The content stream itself is checked for watermark, to prevent use of unauthorized pirated copies, in the watermark checking unit 512. It is then sent to the quality adjust unit 531 for viewing quality level adaptation based on the results of the permission check. The quality adjust unit 531 is provided with input from the checker 523 to adjust the quality or disable the viewing capability based on the determined viewing rights permission that the owner of the switch has to view the content stream. Metering of the video content is also accomplished at this stage by the metering unit 532 connected to the quality adjust unit 531. The units 531 and 532 together form the viewing quality adjust unit 430 of the VRES 500. The watermark unit 541 adds the necessary watermark to indicate the usage, based on the permission. The combined information is sent to the Digital Wavelet Transform (DWT) unit 542 which is used for providing up and down transform based on the feedback input 544 received through the HDMI interface 545, connecting the HDMI interface unit 214 to the viewing terminal 240. The output of the DWT up-down converter 542 is provided to the connection HDCP re-encode unit 543. This is output by means of the HDMI interface 214 to the viewing terminal 240. Hence in addition to the quality and permission control, the quality adjust unit 430 gets feedback 544 from the connected viewing terminal 240 to determine the needed resolution for best possible viewing of the video content. This resolution is implemented on the content stream using a digital wavelet transform (DWT) in the DWT up-down converter 542 to enable the viewer the capability of viewing the content on any display terminal screen at the best allowed/permitted viewing characteristics, automatically.

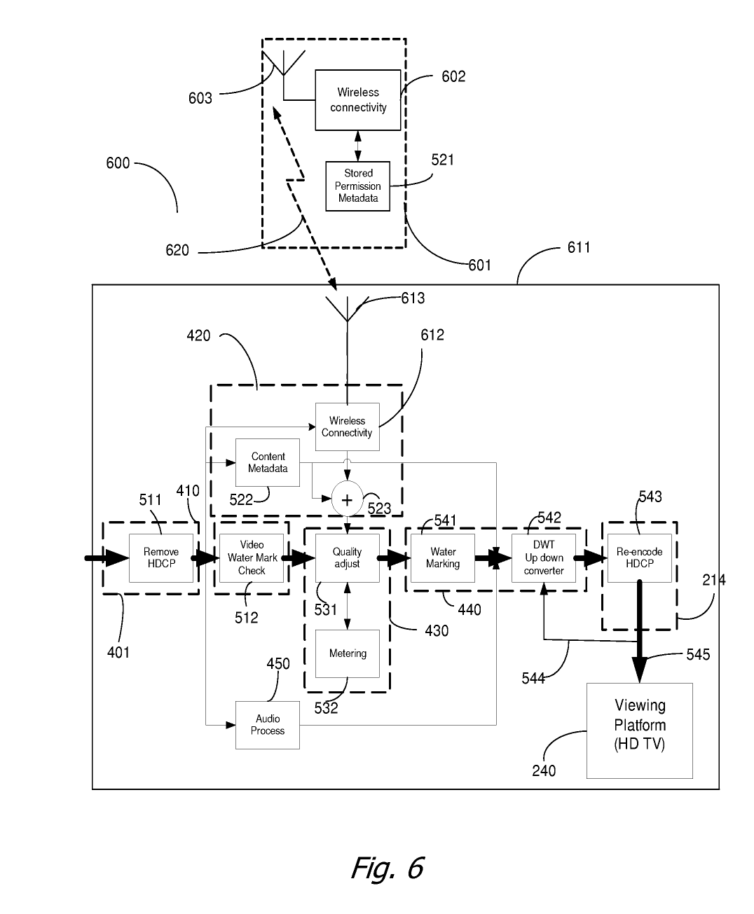

Having such a viewing rights control capability using VRES 500 in an HDMI input/HDMI output system can enable the viewing itself to be agnostic to the origin of the content, whether stored in differing formats, directly supplied by the content supplier or supplied through bought media. The portability of the VRMS 500 hence enables the user to view any stored or transmitted content, for which he has viewing permission, to other locations and viewing terminals, by transporting the VRMS 500 with him. Though the VRMS 500 is shown as a fixed switch connected to the viewing terminal, the VRES 500 can be implemented as a multi-piece VRMS 600 shown in FIG. 6. The viewing rights permission unit 420 has in this system a viewing permission storage unit 601. The paid for viewing permission resides in this separate mobile moving permission storage unit 601 of the system 600 with wireless, infrared or other communication link 620 to the rest of the system which can be considered a semi-stationary part 611. The balance of the viewing rights permission unit 420 in the semi-stationary part of the VRMS 600 can be considered as a fixed permission comparator that extracts the information required for viewing rights management from the content stream and compares it with the stored permission information. The semi-stationary part 611 of the VRMS 600 is connected to the viewing terminal 240 for viewing the content at the permitted quality level based on the viewing permission available on the mobile part 601. The mobile part 601 of the VRMS 600 will then have to be in continuous contact through the wireless unit 602 and the antenna 603 with the wireless block 612 through antenna 613, on the stationary part 611 of the VRMS 600 during content viewing. This mobile enabled implementation of the VRES 500 in a two-part VRMS 600 can, in practice, make individual viewing rights more transportable and transferable. By using this scheme, the only the part of the VRMS 600 that needs to be transported is the mobile part 601 which holds the permission for viewing the content. The permission metadata is stored in the permission storage unit 521 of the mobile part 601 of a VRMS 600. This can then enable any viewing terminal equipped with a stationary part 611 of the VRMS 600 to provide viewing of content at the permitted quality level on any connected viewing terminal.

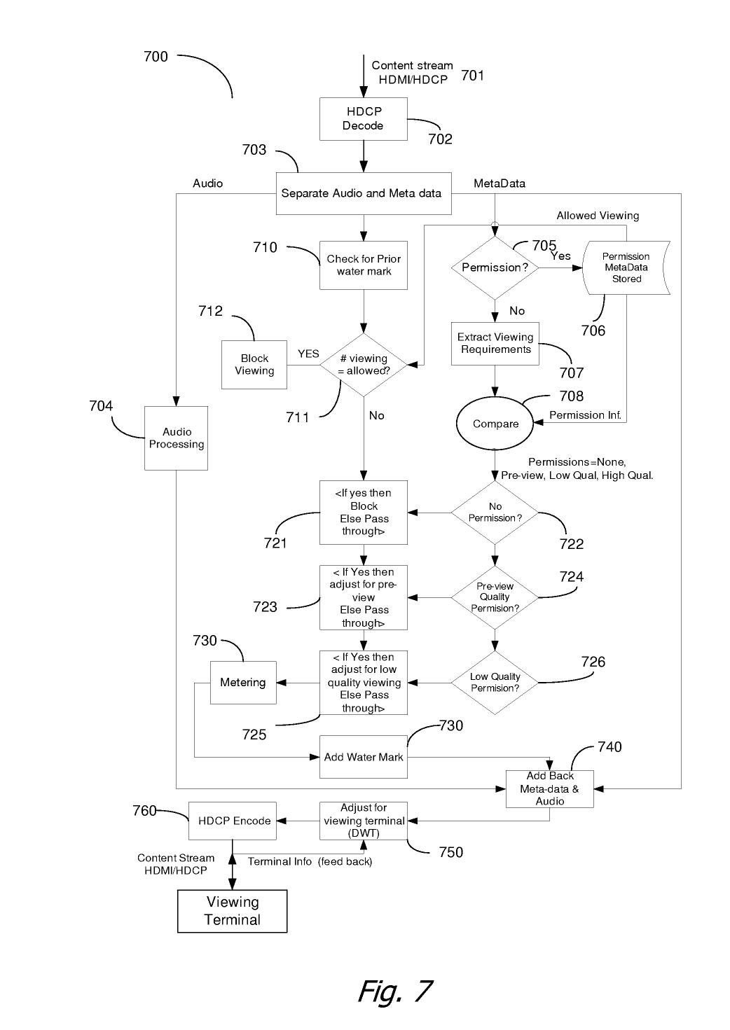

FIG. 7 shows an exemplary and non-limiting flowchart 700 of the operation of a VRES. The flowchart 700 is self-explanatory and hence only brief explanation is provided herein. The video inputs received from various sources of content are decoded, converted into HDMI/HDCP format and supplied to the VRES 400 over an HDMI interface with HDCP encoding at step 701. The HDCP encoding is removed in the HDCP decoder as shown at 702. Then the audio component and the metadata information, contained therein, are separated from the video content in step 703. The audio processing is handled separately as shown at step 704 and added back into the content stream at the end of the process at 740. The metadata is checked for any permission files requested at 705. If such files are available, they are separated and stored as shown in 706 in the permission storage 521. The content is checked for watermarks as in 710 so as to determine the number of times the content has been viewed prior to the current instance. This is checked against the allowed number of views for that content at step 711. If the number of views is above the permission level, viewing of the content is blocked 712. The information on viewing permission requirements are extracted at 707 from the metadata and then checked against the stored permission available (typically paid for), at step 708. Based on the available permission the quality level for viewing is adjusted in steps 721 to 726. Metering of use is done at this stage in step 730. A watermark is added to the video stream to indicate one more viewings at the approved quality level at the next step 740. The originally separated metadata and the audio content are added and integrated back into the stream at this stage in step 740. The content stream at the permitted quality level is now adjusted for optimized viewing on the available viewing terminal by using a digital wavelet up-down transform at 750, based on information received over the connecting HDMI interface. The adjusted content stream is encoded at 760 and streamed out over the HDMI/HDCP to the viewing terminal for viewing.

Even though not specifically detailed in this disclosure a similar system can be established for managing the audio quality/fidelity based on the listening rights.

The invention disclosed hereinabove is described with respect to specific embodiments other embodiments are possible without departing from the scope of the disclosed invention. Furthermore implementations including hardware, software, firmware and various combinations thereof are specifically included.

What is claimed is:

1. An apparatus for enabling video content viewing rights comprising:
an input interface unit enabled for high definition multimedia interface (HDMI);
a watermark checking unit coupled to said input interface unit;
a viewing rights permission unit coupled to said watermark checking unit;
a quality adjustment unit coupled to said viewing rights permission unit;
a water marking unit coupled to said quality adjustment unit; and
an output interface unit enabled for HDMI enabling the coupling to a display terminal;
whereby the input video content stream received by said input interface will be checked for prior viewing and output on said output interface to a viewing terminal at one of a plurality of quality levels based on viewing permissions determined by said viewing rights permission unit.

2. The apparatus of claim 1, wherein said HDMI output enables the apparatus to transmit content to a viewing terminal enabled by an HDMI input interface.

3. The apparatus of claim 1, wherein the HDMI input enable the apparatus to be insensitive to source and format of received content, whether streaming content or pre-stored content.

4. The apparatus of claim 1, wherein said watermark checking unit is enabled to check prior viewing of video content received by said input interface.

5. The apparatus of claim 1, wherein said viewing permissions are stored as metadata in said viewing rights permission unit.

6. The apparatus of claim 5, wherein said viewing permissions are checked against viewing rights requirements contained in said video content by said viewing permission unit.

7. The apparatus of claim 1, wherein said watermarking unit is enabled to add a watermark metadata indicating viewing of content based on permission.

8. The apparatus of claim 1, wherein said quality adjust unit is enabled to cause quality level of video content output to vary based on available viewing permission.

9. The apparatus of claim 1, wherein said apparatus further comprises an up/down converter enabled to receive a feedback from a viewing terminal through said output interface and adjusting an output video content responsive of said feedback.

10. The apparatus of claim 9, wherein said up/down converter is based on a discrete wavelet transform.

11. The apparatus in claim 1, wherein said apparatus is implemented as a transportable viewing rights management switch (VRMS) that can be individually owned to enable the content viewing rights to be associated with the individual owning the VRMS.

12. A transportable viewing rights management system comprising:
an input interface unit for high definition multimedia interface (HDMI);
a watermark checking unit coupled to said input interface unit;
a viewing rights permission unit coupled to said watermark checking unit;
a quality adjustment unit coupled to said viewing rights permission unit;
a watermark unit coupled to said quality adjustment unit; and
an output interface unit enabled for HDMI;
the transportable viewing rights management system being implemented in a transportable viewing rights management switch to enable the individual viewing rights and permissions to be transported with the individual.

13. The transportable viewing rights management system of claim 12, wherein the HDMI input interface and the HDMI output interface enable connectivity for viewing of high-definition decoded video content from any content source on any viewing terminal.

14. The transportable viewing rights management system of claim 12, wherein individual viewing permissions are stored in the viewing rights permission unit of the said viewing rights management system implemented as a viewing rights management switch.

15. The transportable viewing rights permission unit of claim 14, wherein the viewing permissions are stored as metadata in a permission store.

16. The transportable viewing rights permission unit of claim 12, further comprising:
a metadata extraction unit coupled to the input interface unit enabled for extracting from a content stream metadata of viewing rights requirement;
a permissions storage unit coupled to the interface unit for storing of viewing permissions; and
a comparator coupled to both the metadata extraction unit and the permission storage unit and enabled to compare said metadata extracted from the input content stream to said stored permissions.

17. The transportable viewing rights management system of claim 16, wherein video content viewing requirements of said input video content stream are compared with paid for permissions stored in said permissions storage to determine permitted viewing quality level.

18. An individual viewing rights management system enabled to associate viewing rights to an individual comprising a fixed part and a mobile part wherein:
the fixed part comprising:
an input interface unit for high definition multimedia interface (HDMI);
a watermark checking unit coupled to the input interface unit;
a meta data separator unit also coupled to the input interface unit to extract the metadata of required permission conditions;
a wireless connectivity unit, connecting to a wireless connectivity unit on the mobile part;
a permissions comparator unit coupled to the wireless connectivity and to the metadata separator unit;
a quality adjust unit coupled to the permission comparator unit and to the watermark checking units;
a watermark unit coupled to the quality adjust unit; and
an output interface unit enabled for HDMI coupled to the watermark unit; and,
the mobile part having a permissions storage, enabled to communicate over a communication link enabled through the wireless connectivity units with said fixed part;
whereby viewing rights of an individual are transportable by means of said mobile part, thereby enabling the viewing of video content at permissible quality levels on viewing terminals equipped with said fixed part.

19. The individual viewing rights management system of claim 18, wherein said communication link is one of: a wireless communication link, infrared link.

20. A viewing rights management system implemented as a viewing rights management switch enabled to associate viewing right to an individual rather than to a component of the video system, selected from a list comprising a viewing terminal, a storage device, a decoding device.

21. A method of associating viewing rights to an individual comprising:
receiving and storing paid for viewing right permissions information on a portable viewing rights management switch;
receiving decoded video content stream over an input interface;
extracting the viewing rights requirements from said video content stream;
comparing the extracted permission requirements with viewing rights permissions information stored in the switch to determine a permission level;
controlling quality level of said video content stream based on said permission level; and
providing controlled video content over an output interface to a viewing terminal;
said input interface and said output interface being High Definition Multimedia Interface (HDMI) enabled for handling inputs from any decoder with HDMI output interface and outputs to any display terminal that has HDMI input interface.

22. The method of claim 21, wherein the decoded video content stream is HD quality and controlling quality level of said video content stream based on said permission level comprises providing the HD quality decoded video content stream as the controlled video content if the permission level indicates the viewing right permissions information at least satisfies the viewing rights requirements, and providing decoded video content of a quality less than HD quality if the permission level indicates the viewing right permissions information does not satisfy the viewing rights requirements.

23. The method of claim 21, wherein the decoded video content stream is HD cinema quality and controlling quality level of said video content stream based on said permission level comprises providing the HD cinema quality decoded video content stream as the controlled video content if the permission level indicates the viewing right permissions information at least satisfies the viewing rights requirements, and providing decoded video content of a quality less than HD cinema quality if the permission level indicates the viewing right permissions information does not satisfy the viewing rights requirements.
